(19) United States
(12) Patent Application Publication
(10) Pub. No.: US 2012/0043144 A1
(43) Pub. Date: Feb. 23, 2012

(54) POWER TRANSMISSION DEVICE FOR ELECTRIC VEHICLE

(75) Inventors: Sung Wook Hwang, Anyang (KR); Min Woo Han, Gimpo (KR)

(73) Assignee: HYUNDAI MOTOR COMPANY, Seoul (KR)

(21) Appl. No.: 12/953,191

(22) Filed: Nov. 23, 2010

(30) Foreign Application Priority Data
Aug. 20, 2010 (KR) 10-2010-0080569

(51) Int. Cl. B60K 1/00

(52) U.S. Cl. 180/65.1

(57) ABSTRACT

The present invention provides a power transmission device for an electric vehicle, which can easily transmit the rotational power of a motor to a wheel axle even when the motor is arranged in a direction perpendicular to the wheel axle in view of the layout. According to the present invention, it is possible to easily transmit the rotational power of the motor to the wheel axle by arranging the motor in a longitudinal direction perpendicular to the wheel axle, such as in the case where the motor cannot be arranged in a lateral direction parallel to the wheel axle in view of the vehicle layout, thereby increasing the degree of freedom for the design of the layout of the electric vehicle.

### CROSS-REFERENCE TO RELATED APPLICATION

This application claims under 35 U.S.C. §119(a) the benefit of Korean Patent Application No. 10-2010-0080569 filed Aug. 20, 2010, the entire contents of which are incorporated herein by reference.

### BACKGROUND

(a) Technical Field

The present disclosure relates to a power transmission device for an electric vehicle. More particularly, it relates to a power transmission device for an electric vehicle, which can easily transmit the rotational power of a motor to a wheel axle even when the motor is arranged in a direction perpendicular to the wheel axle in view of the layout.

(b) Background Art

An electric vehicle, which is driven by an electric motor as a drive source, is an environmentally-friendly vehicle that does not generate exhaust gas and is essentially equipped with a rechargeable battery and a drive motor.

In a typical electric vehicle, the battery is mounted in an engine compartment or in trunk space behind a rear seat, and the electric motor is connected to each of four wheel axles.

The driving modes of the electric vehicle include an electric vehicle (EV) mode, in which battery power rotates the motor to drive the vehicle, and a regenerative braking (RB) mode, in which braking energy or inertia energy of the vehicle produced by braking or during driving by inertia is recovered by power generation of the motor and is charged in the battery. Because the battery is not fully charged by the regenerative braking mode, it is necessary to periodically charge the battery.

At present, there is an aim to develop various types of power transmission devices that can increase the flexibility in the layout design of power transmission devices for the electric vehicles.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a power transmission device for an electric vehicle, which can easily transmit the rotational power of a motor to a wheel axle. In a particular embodiment, in circumstances where the motor cannot be arranged in a lateral direction parallel to the wheel axle in view of the vehicle layout, the present power transmission device is configured to arrange the motor in a longitudinal direction perpendicular to the wheel axle in the case. The present power transmission device thereby increases the degrees of freedom for the design of the electric vehicle layout.

In one aspect, the present invention provides a power transmission device for an electric vehicle, the power transmission device including: a wheel axle arranged in a first direction, a motor arranged at a predetermined angle with respect to the wheel axle, and a coupling connected between the wheel axle and a shaft of the motor. In a preferred embodiment, the wheel axle is arranged in a lateral direction; the motor is arranged in a longitudinal direction at a predetermined angle with respect to the wheel axle; and the coupling is connected between the wheel axle and a shaft of the motor, which are arranged at a predetermined angle, wherein the rotational power of the motor is transmitted to the wheel axle.

In a preferred embodiment, the coupling includes: an input shaft having a first end integrally connected to the shaft of the motor and a second end including a plurality of power input holes; an output shaft having a first end integrally connected to the wheel axle and a second end including a plurality of power output holes; and a plurality of power transmission rods, each having a first end detachably inserted into a power input hole of the input shaft and a second end detachably inserted into a power output hole of the input shaft. The power transmission rods are configured to have a shape that is bent at an angle formed by the input shaft and the output shaft.

In another preferred embodiment, the angle between the shaft of the motor and the wheel axle, the angle between the input shaft and the output shaft, and the bending angle of each power transmission rod are each about 90°.

In still another preferred embodiment, the input shaft and/or the output shaft have a cylindrical shape. In a preferred embodiment, the power input holes of the input shaft and the power output holes of the output shaft have the same diameter and depth.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a plan view showing a power transmission device for an electric vehicle in accordance with a preferred embodiment of the present invention.

FIG. 2 is a perspective view showing the power transmission device for an electric vehicle in accordance with an embodiment of the present invention.

FIG. 3 is an enlarged perspective view showing a coupling structure between a motor and a wheel axle in the power transmission device for an electric vehicle in accordance with an embodiment of the present invention.

FIGS. 4A to 4D are perspective views showing the power transmission of the power transmission device for an electric vehicle in accordance with an embodiment of the present invention.

Reference numerals set forth in the Drawings includes reference to the following elements as further discussed below:

| | |
|---|---|
| 10: motor | 12: shaft of motor |
| 20: wheel axle | 22: wheel |
| 24: tire | 30: coupling |
| 32: input shaft | 34: power input hole |
| 36: output shaft | 38: power output hole |
| 39: power transmission rod | |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The present invention provides a power transmission device for an electric vehicle. The present transmission device is designed such that it easily transmits the rotational power of a motor to a wheel axle. In particular, the present transmission device arranges the motor in a longitudinal direction perpendicular to the wheel axle, thereby facilitating the transmission of rotational power from the motor to the wheel axle. For example, in circumstances where the motor cannot be or is not easily arranged in a lateral direction parallel to the wheel axle, the present transmission device arranges the motor in a longitudinal direction perpendicular to the wheel axle. This is particularly beneficial in many cases. For example, when the motor is arranged in the longitudinal direction parallel to the wheel axle, the installation space of the motor is often reduced and thus the peripheral parts including the motor are typically integrated in one direction. The present design overcomes these disadvantages and, thereby increases the degrees of freedom for the design of the layout of the electric vehicle.

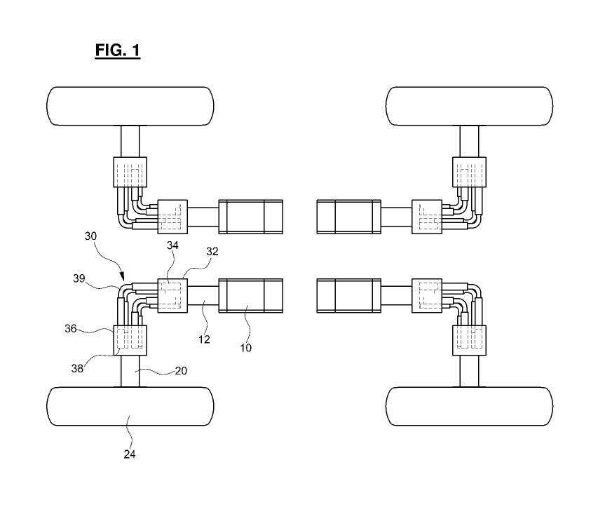

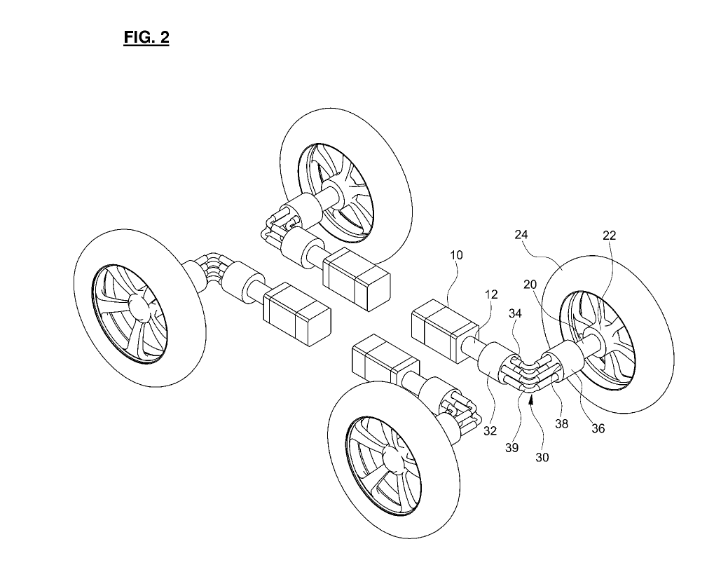

In accordance with one embodiment, as shown in FIGS. 1 and 2, four motors 10 are arranged in a longitudinal (vertical) direction with respect to four wheel axles 20 arranged in a lateral (horizontal) direction such that the wheel axle 20 and a shaft 12 of the motor 10 are arranged perpendicularly to each other.

A coupling 30 capable of transmitting the rotational power of the motor 10 to the wheel axle 20 can further be mounted between the wheel axle 20 and the shaft 12 of the motor 10, which may be arranged perpendicularly to each other as shown in FIGS. 1 and 2.

In a preferred embodiment, the coupling 30 includes an input shaft 32 in connection with the shaft 12, an output shaft 36 in connection with the wheel axle 20, and a plurality of power transmission rods 39 in connection with the input shaft 32 and the output shaft 36. In this embodiment, the shaft 12 and wheel axle can further be arranged perpendicularly to each other. In certain preferred embodiments, the input shaft 32 is coaxially connected to the shaft 12 and the output shaft 36 is coaxially connected to the wheel axle 20.

In an exemplary embodiment, the angle between the shaft 12 10 and the wheel axle 20, the angle between the input shaft 32 and the output shaft 36, and the bending angle of each power transmission rod 39 are all 90°.

The input shaft 32 can have any geometrical structure, and in some embodiments, has a cylindrical structure. In a preferred embodiment, a first end of the input shaft 32 is coaxially and integrally connected to the shaft 12 of the motor 10 and a second end includes a plurality of power input holes 34. In a preferred embodiment, the power input holes are arranged in a circumferential direction at regular intervals and have the same diameter and depth.

The output shaft 36 can also have any geometrical structure, and in some embodiments, has a cylindrical structure. In a preferred embodiment, a first end (outer end) is coaxially and integrally connected to the wheel axle 20 and the second end (inner end) includes a plurality of power output holes 38. In a preferred embodiment, the power input holes are arranged in a circumferential direction at regular intervals and have the same diameter and depth.

The plurality of power transmission rods 39 can be provided in any geometrical structure and shape, and in certain preferred embodiments the rods 39 have a rod-like structure with a circular cross section, wherein the rods 39 are bent along their lengths. In a preferred embodiments, the rods 39 are bent along their lengths vertically to form an angle. One end of each power transmission rod 39 is detachably inserted into the power input holes 34 of the input shaft 32, and the other ends of the power transmission rods 39 are detachably inserted into the power output holes 38 of the output shaft 36.

In some embodiments, a universal joint (U-joint) is used as a conventional coupler which transmits the rotational power of an input shaft to an output shaft in a state where the input shaft and the output shaft are arranged at a predetermined angle. However, use of the universal joint generally results in angular velocity variations. In particular, when the input shaft is rotated by one turn, the output shaft is also rotated by one turn (the same RPM). However, the angular velocity per revolution of the output shaft is not constant, and thus the angular velocity is divided into a high region and a low region. Further, when the angle between the input shaft and the output shaft is increased to nearly 90°, the change of the angular velocity is significantly increased, the rotation for power transmission is not smoothly performed, and significant vibration and power loss occur.

The present invention overcomes these problems and provides a device that is capable of efficiently transmitting the rotational power of the input shaft 32 to the output shaft 36 due to the rotation and linear movement of the power transmission rods 39. The present device is further capable of such efficient transmission of rotational power even when the input shaft 32 connected to the shaft 12 of the motor 10 and the output shaft 36 connected to the wheel axle 20 are arranged at a 90° angle with respect to each other.

Next, the power transmission of the power transmission device for an electric vehicle in accordance with the present invention will be described.

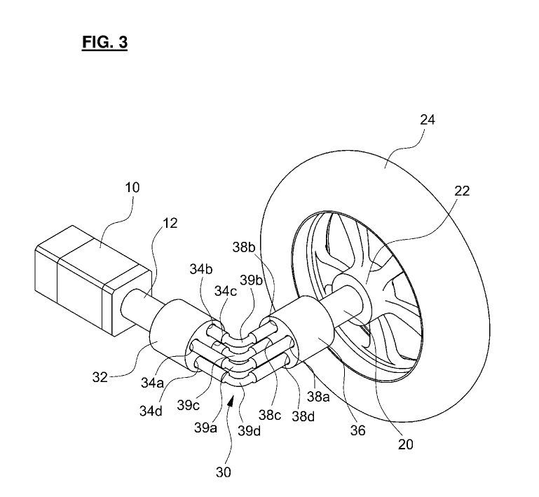

In the following description, the plurality of power input holes 34 are referred to as first to fourth power input holes 34a to 34d, on the assumption that the plurality of power input holes 34 formed in the input shaft 32 are four in number, and the plurality of power output holes 38 will be referred to as first to fourth power output holes 38a to 38d, on the assumption that the plurality of power output holes 38 formed in the output shaft 36 are four in number, as shown in FIG. 3. As such, the power transmission rods 39, which are detachably inserted into the first to fourth power input holes 34a to 34d and the first to fourth power output holes 38a to 38d will be referred to as first to fourth power transmission rods 39a to 39d, as further depicted in FIG. 3. However, it is understood that the present invention can suitably be provided with any number of power input and output holes 34, 38 and associated power transmission rods 39, and the following description suitably applied to such variations in number.

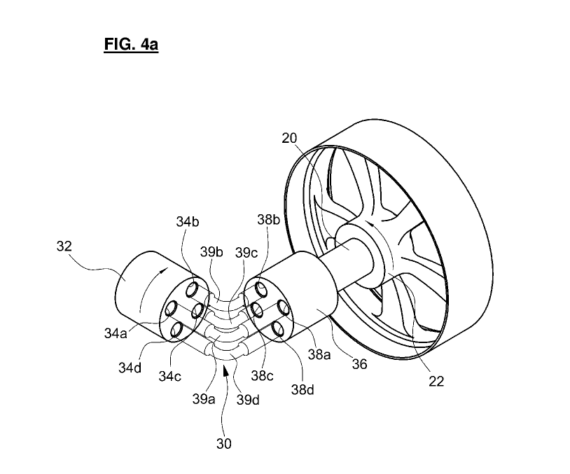

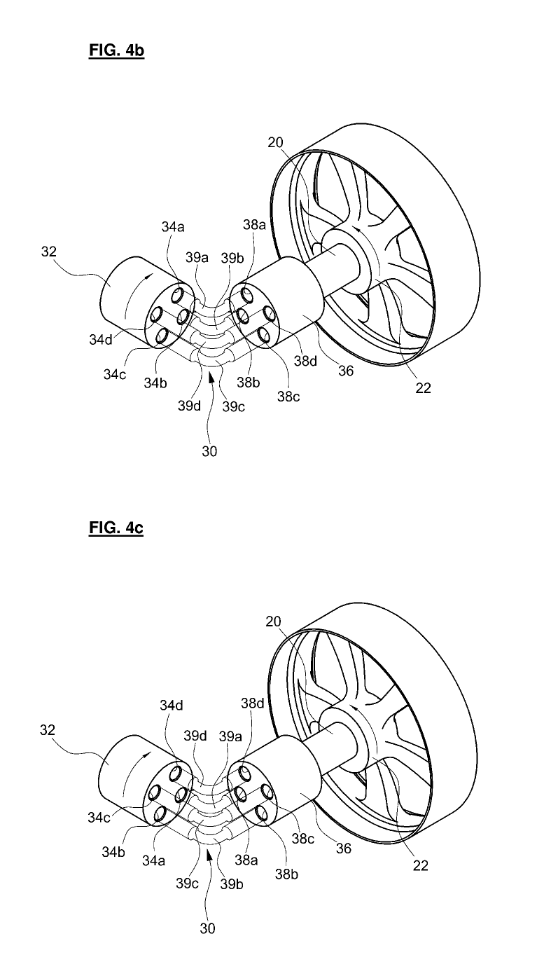

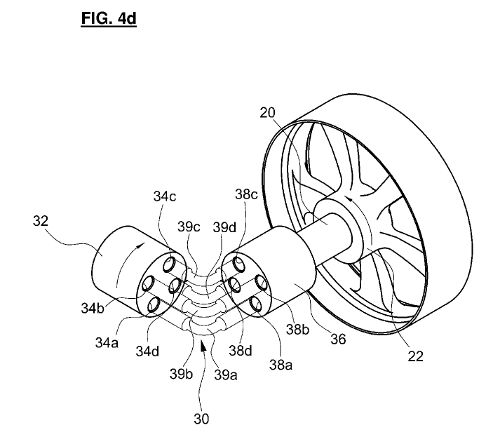

When the motor 10 is rotated during use, the rotational force of the motor 10 is input to the input shaft 32 through the shaft 12 of the motor 10. As a result, as shown in FIGS. 4A to 4D, the input shaft 32 and the output shaft 36 are rotated by one turn. When the input shaft 32 is rotated in a clockwise direction, as shown by the arrow in FIGS. 4a-4d, a wheel 22 connected to the wheel axle 20 and a tire 24 mounted on the wheel (shown in FIG. 3) as well as the output shaft 36 and the wheel axle 20 are rotated in a counterclockwise direction, as shown by the arrow on wheel axle 20 in FIGS. 4a-d.

In particular, when the input shaft 32 is rotated in the clockwise direction, one end of each of the first to fourth power transmission bars 39a to 39d, which are inserted in the first to fourth power input holes 34a to 34d of the input shaft 32, rotates in the clockwise direction. As such, the circumferential position of each of the first to fourth power transmission bars 39a to 39d varies as depicted in FIGS. 4a-d. At the same time, the other end of each of the first to fourth power transmission bars 39a to 39d, which are inserted in the first to fourth power output holes 38a to 38d of the output shaft 36, rotates in the counterclockwise direction, and its circumferential position varies as depicted in FIGS. 4a-d. As a result, the rotational power of the input shaft 32 is easily transmitted to the output shaft 36.

For a better understanding of the present invention, the operation of the first power transmission rod 39a, having one end inserted into the first power input hole 34a of the input shaft 32 and the other end inserted into the first power output hole 38a of the output shaft 36 will be described as follows.

Referring to FIG. 4A, since the both ends of the first power transmission rod 39a are inserted into the first power input hole 34a and the first power output hole 38a, the perpendicular distance between the input shaft 32 and the output shaft 36, (i.e., between the first power input hole 34a of the input shaft 32 and the first power output hole 38a of the output shaft 36) is at a maximum. As such, both ends of the first power transmission rod 39a are maximally withdrawn from (while still remaining within) the first power input hole 34a of the input shaft 32 and the first power output hole 38a of the output shaft 36, respectively.

In this state, when the input shaft 32 is rotated in the clockwise direction by rotation of the motor 10, as shown in FIGS. 4B and 4C, the circumferential position of the first power input hole 34a varies in the clockwise direction. At the same time, the position of end of the first power transmission rod 39a, which is disposed in the first power input hole 34a, varies in the same manner, and the other end of the first power transmission rod 39a, which is disposed in the first power output hole 38a of the output shaft 36 is also rotated in the counterclockwise direction, thereby rotating the output shaft 36 in the counterclockwise direction.

As shown in FIGS. 4B and 4C, since the both ends of the first power transmission rod 39a are inserted into the first power input hole 34a of the input shaft 32 and the first power output hole 38a of the output shaft 36, respectively, in a state where the perpendicular distance between the first power input hole 34a of the input shaft 32 and the first power output hole 38a of the output shaft 36 is at a minimum, both ends of the first power transmission rod 39a are inserted to the maximum depth within the first power input hole 34a of the input shaft 32 and the first power output hole 38a of the output shaft 36.

Subsequently, as shown in FIG. 4D, when the input shaft 32 is rotated in the clockwise direction, both ends of the power transmission rod 39a are angularly rotated in different directions and are withdrawn from the first power input hole 34a of the input shaft 32 and the first power output hole 38a of the output shaft 36 to the maximum level, but without being completely withdrawn (i.e. while still remaining within the holes 34a and 38a).

While the operation of the first power transmission rod 39a has only been described in further detail as above, the second to fourth power transmission rods 39b to 39d operate in the same manner, and, thus, the present design easily transmits rotational power of the input shaft 32 to the output shaft 36, even when they are arranged perpendicular with respect to each other.

According to the present invention, it is possible to easily transmit the rotational power of the motor to the wheel axle. In particular, transmission of rotational power from the motor to the wheel axle is facilitated by arranging the motor in a longitudinal direction perpendicular to the wheel axle, and by connecting the shaft of the motor and the wheel axle, which form a predetermined angle, by a vertically bent coupling. Such an arrangement is particularly beneficial, for example, in the case where the motor cannot be arranged in a lateral direction parallel to the wheel axle in view of the vehicle layout. Further, in accordance with the present invention the motor is arranged in the longitudinal direction perpendicular to the wheel axle, and thus it is possible to increase the degree of freedom for the design of the layout of the electric vehicle.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A power transmission device for an electric vehicle, the power transmission device comprising:
a wheel axle arranged in a lateral direction;
a motor arranged in a longitudinal direction and at a predetermined angle with respect to the wheel axle; and
a coupling that connects the wheel axle and a shaft of the motor, wherein the wheel axle and the shaft are arranged at a predetermined angle,
whereby rotational power of the motor is thereby transmitted to the wheel axle.

2. The power transmission device of claim 1, wherein the coupling comprises:
an input shaft having a first end integrally connected to the shaft of the motor and a second end having a plurality of power input holes;
an output shaft having a first end integrally connected to the wheel axle and a second end having a plurality of power output holes; and
a plurality of power transmission rods, each power transmission rod having an angled shape configured such that a first, end of each rod is detachably inserted into a power input hole of the input shaft and a second end of each rod is detachably inserted into a power output hole of the input shaft.

3. The power transmission device of claim 2, wherein the angle between the shaft of the motor and the wheel axle, the angle between the input shaft and the output shaft, and the angle of each power transmission rod are each about 90°.

4. The power transmission device of claim 2, wherein the input shaft and the output shaft have a cylindrical shape.

5. The power transmission device of claim 2, wherein the power input holes of the input shaft and the power output holes of the output shaft have the same diameter and depth.
